(19) United States
(12) Patent Application Publication
(10) Pub. No.: US 2007/0127196 A1
(43) Pub. Date: Jun. 7, 2007

(54) Sliding Second Screen

(75) Inventor: Bobbie Lee King JR., Princeton, NJ (US)

Correspondence Address: Bobbie Lee King Jr., F1056 Frist Campus Center, Princeton University, Princeton, NJ, 08544, US

(73) Assignee: Bobbie Lee King JR., Princeton, NJ (US)

(21) Appl. No.: 11/164,850

(22) Filed: Dec. 7, 2005

(51) Int. Cl. G06F 1/16

(52) U.S. Cl. 361/681

(57) ABSTRACT

The invention was imagined as a response to the problems associated with limited screen space of portable computing devices (i.e. laptops, PDAs, etc.). Because of issues of portability, size and weight these devices have been limited to a single, undersized screen in which relatively small amounts of information can be displayed at the same time. Though there exists some means of attaching secondary displays to the devices, there exists no practical way of taking these secondary devices with the user (i.e. allowing for complete portability of all aspects of the devices). The invention rests on the premise of creating a new system that allows for the portability of secondary display devices to solve the issues described in the background section. By placing a secondary screen behind the primary screen of the device, while still maintaining the portability of the original portable computing device, we solve the above problem.

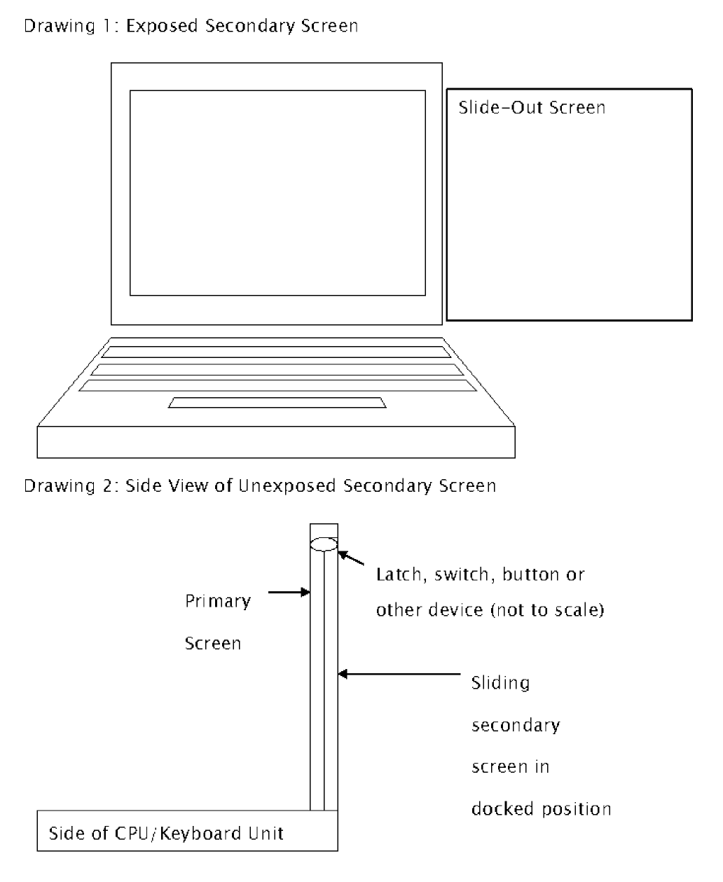

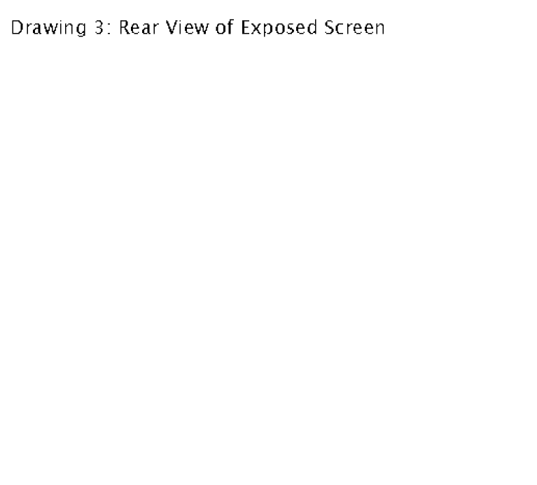

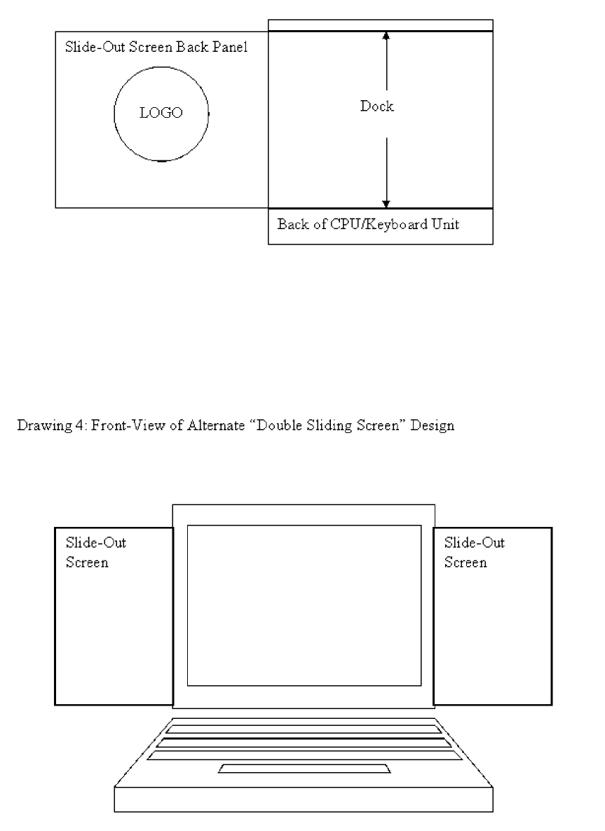

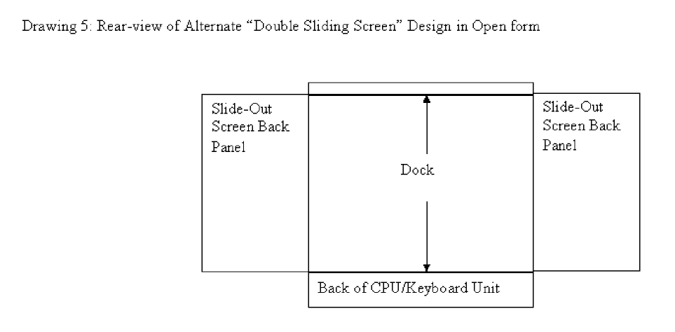

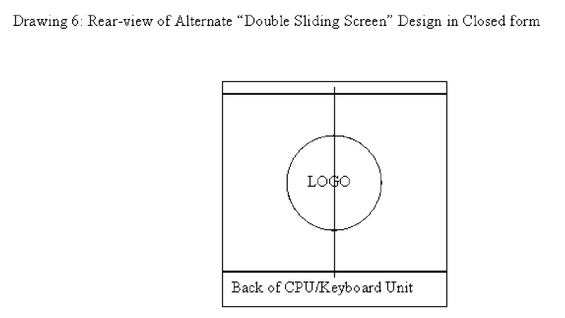

The screen is encased in a lightweight metal and/or durable plastic and loaded in a thin but recognizable docking bay behind the primary screen. It is connected to the central processing unit by cables within the docking bay which are not visible to the user or wirelessly. The device, when docked, is loaded such that the release of a switch or button or other apparatus will release the screen from the docking bay and allow the user to expose the screen so that it may act as a secondary screen to the primary screen.

The screen may activate manually or automatically depending on the preferences of the users and the software available to them. Once the user has completed using the secondary device, he may slide the secondary screen back into the docking bay and the docking bay may either latch itself automatically or be latched manually by the user. The screen may either shut down automatically, or manually, depending on the preference of the user.

The screen casing and loading mechanisms may operate on a slide attached to the back of the primary screen casing; or, on a sliding mechanism located within the docking bay.

The best mode seems to be the docking apparatus which is attached to the screen casing. This is because the screen weight is better supported in this way. The invention only requires an added thickness screen casing and a docking bay which might not be much different that the docking bays of the standard laptop CD ROM drives. An added external or internal connection for the secondary screen may be added so that the user loses no utility from his standard portable computing device.

What is claimed is:

1. My claim is to the invention of any device or modification that extends the standard screen of the laptop using a secondary sliding screen. The idea to “dock” a secondary screen behind the primary screen to be used on the portable computing device at the user's discretion is strictly my own.
